(19) United States
(12) Patent Application Publication
(10) Pub. No.: US 2022/0176380 A1
(43) Pub. Date: Jun. 9, 2022

(54) A HOLDER FOR PIPETTE TIPS

(71) Applicant: RANDOX LABORATORIES LTD, Crumlin (GB)

(72) Inventors: Paul Courtney, Crumlin (GB); Christine Maybin, Crumlin (GB); Stuart Jackson, Crumlin (GB)

(21) Appl. No.: 17/602,863

(22) PCT Filed: Apr. 8, 2020
(86) PCT No.: PCT/GB2020/050913

§ 371 Date: Oct. 11, 2021

(30) Foreign Application Priority Data
Apr. 12, 2019 (GB) 1905201.8

(51) Int. Cl. B01L 9/00

(52) U.S. Cl. CPC B01L 9/543; G01N 2035/0434

(57) ABSTRACT

A holder for holding pipette tips of a molecular diagnostics assay analyser comprises a frame comprising a plurality of bores which are separated from each other, each bore configured to removably hold a first end of a pipette tip and a drip tray spaced apart from the plurality of bores, the drip tray configured to receive a second end of a pipette tip when said pipette tip is held by one of the plurality of bores, thereby allowing the pipette tip to be placed in the holder for re-use.

### FIELD

The present invention relates to a holder for holding pipette tips of a molecular diagnostics assay analyser.

### BACKGROUND

In biological analysers, disposable pipette tips are used in places where contamination control is critical or where the cleaning of non-disposable pipette tips is not practical. A significant part of assay automation requires moving fluids from one place to another. In most systems this is achieved by using pipette tips for the aspiration and the dispensing of fluids. Where disposable pipette tips are used, each aspiration/dispense can mean that the used pipette tip is moved to a waste disposal unit and so a new pipette tip is required for the next part of the process.

The number of disposable pipette tips needed for an assay that requires multiple fluid movements in an analyser machine that processes a number of samples in a single batch can be as many as 10 per sample. As is evident, large amounts of plastic waste are therefore produced for each assay. Additionally, the cost of buying and storing large numbers of new pipette tips is high.

There is therefore a need to reduce the amount of plastic waste, as well as the costs, associated with carrying out biological molecular assays.

### SUMMARY OF THE INVENTION

According to an aspect there is provided a holder for holding pipette tips of a molecular diagnostics assay analyser comprising a frame comprising a plurality of bores which are separated from each other, each bore configured to removably hold a first end of a pipette tip and a drip tray spaced apart from the plurality of bores, the drip tray configured to receive a second end of a pipette tip when said pipette tip is held by one of the plurality of bores, thereby allowing the pipette tip to be placed in the holder for re-use.

The frame of the holder therefore holds a plurality of pipette tips separately from each other which helps prevent cross-contamination from one pipette tip to another tip, as the pipette tips are prevented from touching each other. This allows the pipette tips to be re-used, rather than disposed of, because they have not been contaminated with contents of another pipette tip.

Use of the holder can drastically reduce the number of new pipette tips required for an assay. In some cases, the holder can halve the number of new pipette tips needed purely by providing a space within the assay analyser where used pipette tips can ‘rest’ and be reused later. The holder therefore helps reduce costs associated with purchasing and maintaining a stock of disposable pipette tips and helps reduce the amount of plastic waste produced by a laboratory.

The holder additionally allows an analyser to reuse disposable tips for particular parts of an assay without affecting the overall performance of the assay.

The drip tray of the holder prevents any contents of the pipette tips which may still remain within or on the pipette tips from coming into contact with the other surfaces of the analyser, preventing cross-contamination from the pipette tips to the rest of the analyser. Additionally, the drip tray acts as a collector for any fluid remaining within or on the pipette tips which reduces the risk of leftover fluid coming into contact with any electronics in the analyser and consequently reduces the chance of short circuits occurring.

Each bore may have a central longitudinal axis and the central longitudinal axes of the plurality of bores may be substantially parallel to each other. This ensures that the pipette tips are held substantially upright (e.g. vertically) within each bore, helping reduce the likelihood of adjacent pipette tips from coming into contact with each other.

The bores may be through-bores. This allows the pipette tip to be inserted completely through the bores ensuring each pipette tip is securely held within its corresponding bore. This also allows the second end of the pipette tip to be received by the drip tray so that the bores do not become contaminated with any fluid that may remain within or be contained on the pipette tips.

Each of the plurality of the bores may extend along a portion of the pipette tip from the first end of the pipette tip towards the second end of the pipette tip. Having the bore extend along a portion, or length, of the pipette tip increases the surface area of the pipette tip which is held by the frame. This ensures the pipette tips are held securely within the frame which reduces movement of each pipette tip within its bore. Reducing the movement of each pipette tip within the bores reduces the chance that adjacent pipette tips will accidentally come into contact with each other and so the likelihood of cross-contamination between adjacent pipette tips is reduce.

The extent of the pipette tip along which the bore extends may be chosen such that each bore holds a pipette tip in a manner which prevents a longitudinal axis of the pipette tip from substantially deviating from a longitudinal axis of the bore, such that substantial lateral motion of the pipette tip in the bore is prevented. This has the effect that the pipette tips are generally always upright (e.g. vertical) when held in the bores. By limiting the lateral, or sideways, movement of each pipette tip within its corresponding bore, adjacent pipette tips held in the frame are prevented from coming into contact with each other, which reduces the chance of cross-contamination between adjacent pipette tips allowing the pipette tips to be reused. The lateral movement of each pipette tip within the respective bore when held within the bore may be achieved by the diameter of the bore relative to the diameter of the pipette tip and/or the length of the bore. These attributes of the bore limit the angle which the pipette tip is able to deviate from the central longitudinal axis of the bore due to the walls of the bore preventing further movement.

The plurality of bores may be linearly arranged within the frame. This may make it easier for an external device, for example a robotic arm, to load and unload the frame with pipette tips as a result of the orderly arrangement of bores.

In some cases, the holder may comprise 16 (sixteen) bores. In other cases, the holder may comprise a multiple of four bores.

The holder may further comprise a gap between the frame and the drip tray. This provides the user with easy access to the drip tray for example, to assist with cleaning or accessing the contents of the drip tray.

The gap between the frame and the drip tray may be fixed. Alternatively, the gap between the frame and the drip tray may be adjustable. This allows the user to customise the holder, for example depending on the size of the pipette tips used. This ensures that the second end of the pipette tip is always received within the drip tray instead of terminating a distance above the drip tray. This ensures that the risk of contamination is reduced, regardless of the size of the pipette tip being used.

The drip tray may be partitioned into a plurality of sections. This may provide a plurality of discrete compartments into which the second ends of the pipette tips are received. This helps reduce the chance of the second end of the pipette tips from coming into contact with each other, reducing the likelihood of cross-contamination by reducing access within the drip tray for one pipette tip second end to deviate from within a particular compartment.

The number of sections in the drip tray may be equal to the number of bores in the frame. This ensures that each pipette tip which has been inserted into the frame has its own section to receive the second end of the pipette tip. Ensuring that the pipette tips do not have to share sections in the drip tray prevents adjacent pipette tips from coming into contact with each other, reducing cross-contamination.

Each section may be arranged opposite a corresponding bore in the frame. This ensures that the pipette tips are held vertically within the holder, rather than at an angle. Holding the pipette tips vertically reduces the chance that adjacent tips are going to come into contact with each other, preventing cross-contamination.

The sections may be configured to receive a bottle. The bottle may be a reagent bottle. This allows the holder to be used as a reagent reservoir for assays that need reagents that cannot be accommodated in any other part of the analyser or are preferably located at the holder.

The drip tray may be detachable from the holder. This allows the user to easily dispose of the contents of the drip tray, and clean the drip tray, while reducing the risk of contaminating the rest of the analyser during the cleaning process.

The frame may be movable between a raised position and a lowered position within the holder. This provides the user with easy access to both the frame for cleaning and maintenance purposes. Additionally, the contents of the frame, such as the pipette tips, may be accessed more easily by a user when the frame is in the raised position, which is likely to bring the frame closer to the user.

In some cases the separation between the drip tray and the plurality of openings is the same when the frame is in both the raised position and the lowered position. This provides with user with easy access to the drip tray when the frame is in the raised position. In other cases, the separation between the drip tray and the plurality of openings is different when the frame is the raised position compared to the lowered position.

The holder may further comprise an adjustment mechanism configured to move the frame between the raised position and the lowered position. The adjustment mechanism facilitates movement of the frame and so makes adjustment of the holder by the user easier.

The adjustment mechanism may comprise a gripping mechanism configured to maintain the frame in the raised position. This ensures that the frame is maintained in the raised position instead of returning to the lowered position under the influence of gravity. This means that the user does not have to hold the frame in the raised position but instead has both hands free to interact with the holder.

The gripping mechanism may comprise a mechanical catch. A mechanical catch is a simple means of providing a mechanism which can maintain the position of the frame against the force of gravity. The mechanical catch can easily be overcome by a user in order to return the frame to the lowered position. The user is therefore easily able to raise and lower the frame within the holder, making the holder simple and easy to use.

The holder may further comprise a sensor configured to detect when the frame is in the lowered position. The sensor can inform the analyser that the frame is in the lowered position. If the frame is not in the lowered position, the sensor can inform the analyser which is subsequently prevented from operating. Preventing operation of the analyser when the frame is not in the lowered position avoids the frame from obstructing or interfering with other components of the analyser. Furthermore, this ensures correct placement of the frame when the analyser is being used, helping reduce the chance of cross-contamination between pipette tips that are held within the frame of the holder.

### BRIEF DESCRIPTION OF THE DRAWINGS

Embodiments of a holder will now be described by way of example only, with reference to the accompanying drawings in which:

FIG. 1 is a plan view of an example analyser with which an example holder is used.

FIG. 2 is a perspective view of a holder in a lowered position, the holder comprising pipette tips; and

FIG. 3 is a perspective view of a holder in a raised position.

### SPECIFIC DESCRIPTION

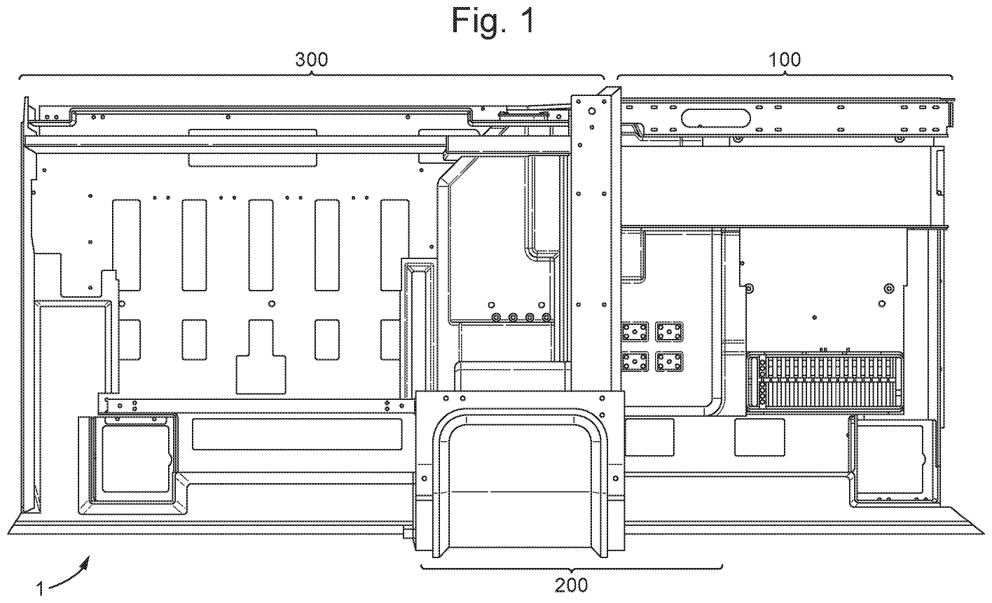

The holder described in relation to the figures is used in an analyser, generally illustrated at 1 in FIG. 1. The analyser is suitable for conducting an assay on fluid or liquid samples. Typically the holder is used in relation to an analyser suitable for conducting a molecular diagnostic assay on samples. In such an analyser the sample is extracted and purified, an amplification process is conducted on the purified sample using PCR and then the constituents of the amplified sample are detected by using various reagents and detection methods.

The analyser is typically separated into different sections where each of the extraction and purification, amplification and detection steps is carried out. Each of these steps are respectively carried out in a first section 100, second section 200 and third section 300 as shown in FIG. 1. The holder shown in the figures is located in the section where the detection is carried out.

As set out below, pipette tips are used to transport fluids within the analyser. These fluids may be sample fluid, wash, reagents, waste or any other fluid used within the analyser as part of the assay. The pipette tips are transported connected to pipettors, which are attached to robotic arms that provide a programmable translation system for moving components within the analyser.

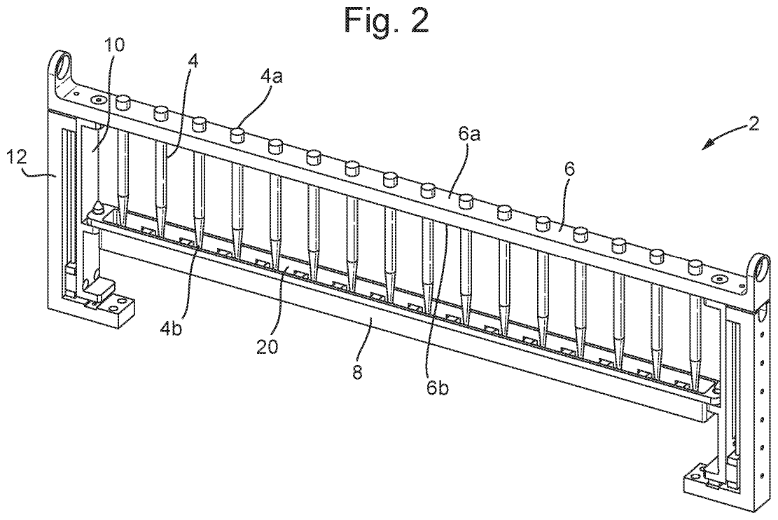

FIG. 2 shows an example of a holder 2. This is used for holding a plurality of pipette tips 4. In this example the holder is located in a molecular diagnostics assay analyser 1. The holder 2 comprises a frame 6, configured to hold the pipette tips 4, and a drip tray 8 which is spaced apart from the frame 6. The frame 6 and drip tray 8 are attached to a plurality of support arms 10, each support arm 10 being mounted on a support leg 12. In the example shown in FIG. 2, there are two support arms 10.

As can be seen in FIG. 2, the frame 6 is in the form of an elongate bar 14 having a generally rectangular shape. The frame 6 comprises a plurality of bores 16 which are separated apart from each other along the length of the frame 6. The bores 16 are therefore linearly arranged within the frame 6. The separation between each bore 16 is equal so that the bores 16 are equally spaced along the frame 6.

The pipette tips 4 comprise a first end 4a, corresponding to an end of the pipette tip 4 comprising a bulb portion of the pipette, and a second end 4b, corresponding to a dispensing portion. The bores 16 are sized to receive and hold the first end 4a of the pipette tip 4. In the field of molecular diagnostic assays, pipette tips 4 are standardized pieces of equipment, and so their diameter is also standardised. The bores 16 of the frame 6 are therefore sized to receive pipette tips of one or more standard sizes. A typical standard pipette tip has a diameter of 7 mm along the main body of the pipette tip, at an interface point between the pipette tip 4 and the frame 6. Thus, in some examples, the bores 16 of the frame 6 are sized to receive pipette tips 4 having a diameter of 7 mm. The bulb of the pipette tip 4 acts as a stop so that the pipette tip 4 cannot be inserted too far into the bore 16. Instead, the pipette tip 4 is inserted into the bore 16 up to the bulb portion, which rests on an upper surface 6a of the frame 6, preventing further insertion of the pipette tip 4 into the respective bore 16. This provides a convenient way of ensuring that each of the pipette tips 4 are held by the frame 6 at the same height, which makes it easy to insert and remove the pipette tips 4.

The bores 16 are through-bores, extending completely through a thickness of the frame 6. In this example this is between a lower surface 6b (also referred to as a base) of the elongate bar and the upper surface 6a. The length of each bore 16 is therefore the same as the thickness of the frame 6. Each bore 16 has a vertical axis 18 (in this example corresponding to a central longitudinal axis), which is substantially parallel to the vertical axes 18 of all the other bores 16. This means the bores 16 are arranged parallel to each other in the frame 6.

Each bore 16 is sized to extend along a portion of the length of a pipette tip 4, rather than along the full length of the pipette tip 4. The length of each bore 16 therefore represents a portion of the length of the pipette tip 4.

The portion of the pipette tip 4 along which the bore 16 extends is chosen so that the bore 16 holds the pipette tip 4 in the frame 6 in a manner which prevents substantial lateral motion of the pipette tip 4 within the bore 16. In more detail, each pipette tip 4 has a vertical axis (such as a central longitudinal axis) extending along the length of the pipette tip 4. When the pipette tip 4 is held within the frame 6, the vertical axis of the pipette tip 4 is parallel with, and substantially co-axial with, the vertical axis of the bore 26 in which the tip 4 is being held. Due to the bore 16 extending along a length of the pipette tip 4, movement of the pipette tip 4 within the bore 16 is restricted. This has the effect that the vertical axis of the pipette tip 4 does not significantly deviate from the vertical axis of the bore 16.

As each pipette tip 4 is prevented from significantly deviating from the vertical axis of the bore 16 by limiting the lateral, or sideways, movement of each pipette tip 4 within its corresponding bore 16, adjacent pipette tips 4 held in the frame 6 are prevented from coming into contact with each other. Whilst each pipette tip 4 may have a small range of movement, this range of movement is not great enough to allow the second end 4b of a first pipette tip 4 (or any other part of the first pipette tip 4) to touch a second adjacent pipette tip 4.

It is important to ensure that adjacent pipette tips 4 cannot come into contact with each other in order to prevent contamination from one pipette tip 4 to another pipette tip 4. In use, each pipette tip 4 will have been used to deposit a fluid (typically a liquid) onto a substrate or to transfer that fluid from one location to another, for example, in the analyser. Different pipette tips 4 are often used for different fluids. If the fluid from one pipette tip 4 comes into contact with the fluid from another pipette tip 4, both pipette tips 4 will be cross-contaminated with the fluid from the other pipette tip 4. This means that neither pipette tip 4 can be used again, otherwise the validity of the experiment or assay will be compromised. These contaminated pipette tips 4 therefore have to be discarded and new pipette tips 4 need to be used. For large experiments, or assays with a more than one or two steps, each of which involve large numbers of pipette tips 4 and many different experimental fluids, the risk of cross contamination greatly increases. High levels of cross contamination mean that large numbers of pipette tips 4 need to be thrown away, which is both costly and not environmentally friendly. By ensuring that fluid form one pipette tip cannot cross contamination another pipette tip 4, the tips 4 can be reused which saves costs and reduces the amount of waste products.

As mentioned previously, the holder 2 includes a drip tray 8 which is positioned underneath the frame 6, as shown in FIG. 2. In the example shown in FIG. 2, the drip tray 8 is located a fixed distance apart from the frame 6 of the holder 2, creating a gap between the drip tray 8 and the frame 6. In other examples, the distance between the frame 6 and the drip tray 8 may be adjustable. Returning to the example of FIG. 2, this shows the drip tray 8 has a generally elongated U-shaped configuration and has a length that is about the same as the length of the frame 6. The U-shaped configuration of the drip tray 8 causes the drip tray to provide a trough capable of holding liquid.

As can be seen in FIG. 2, the drip tray 8 is partitioned into a plurality of sections 20. The number of sections 20 in the drip tray 8 corresponds to the number of bores 16 in the frame 6. Thus, each section 20 is associated with a corresponding bore 16. This provides a one-to-one relationship between the sections 20 and the bores 16.

The drip tray 8 receives the second end 4b of each of the pipette tips 4 when they are held in the frame 6 (so after they have been inserted into the bores 16). The second end 4b of the pipette tip 4 is received by the section 20 of the drip tray 8 that is aligned with the bore 16 into which is first end 4a of the pipette tip 4 is being held. In other words, due to the frame 6 being located above the drip tray 8, the second end 4b of each pipette tip 4 is received by the respective section 20 of the drip tray 8 directly below the each respective bore 16.

Since each bore 16 has a corresponding section 20 associated with it, the pipette tips 4 are held vertically (so generally upright) between the bore 16 and the corresponding section 20. For example, the first end 4a of a first pipette tip 4 is held by the first of the plurality of bores while the second end 4b of the same pipette tip 4 is received by the first of the plurality of sections. The first end 4a of a second pipette tip 4 is held by the second of the plurality of bores whilst the second end 4b of the same second pipette tip 4 is received by the second of the plurality of bores. This arrangement of pipette tips 4 in the holder 2 is shown in FIG. 2. The drip tray 8 is therefore directly beneath the frame 6.

As explained above, the drip tray 8 is for receiving the second end 4b of the pipette tips 4 in order to catch any remaining fluid that might be present in the pipette tip 4 after the pipette tip 4 has been used or on the outside of the pipette tip 4. The drip dray 8 therefore prevents any leftover fluid from dripping onto other parts of the analyser apparatus, including any electronics. This drip tray 8 therefore ensures that surfaces of the analyser are not contaminated by any fluid remaining in or on the pipette tip 4 once the pipette tip 4 has been used. Additionally, the drip tray 8 avoids fluid from coming into contact with any electrical components of the analyser, preventing short circuits.

As well as receiving the second end 4b of the pipette tips 4, the drip tray 8 can alternatively or additionally be used to store bottles (not shown), or containers (not shown), for use with the analyser. Each bottle is held in place within a section 20 in the drip tray 8. Generally, bottles and containers for use with molecular diagnostics assay analysers come in standard shapes and sizes. The sections 20 of the drip tray 8 are therefore sized so that they can receive these standardised bottles.

Both the frame 6 and the drip tray 8 have generally elongate structures including first and second ends. Each of the first ends of both the frame 6 and the drip tray 8 are attached to one of the plurality of support arms 10 while the second ends of both the frame 6 and the drip tray 8 are attached to the other of the plurality of support arms 10, as can be seen in FIG. 2.

The frame 6 is connected to the support arms 10 by fasteners. In the example shown in FIG. 2, these fasteners are screws which connect through the frame 6 to a threaded portion (not shown) in each support arm.

The drip tray 8 is removably connected to each support arm 10. The removable connection is provided by a spur at each end of the drip tray 8 that extends outwardly from the drip tray along an axis passing along the length of the drip tray 8. Each spur has a through-bore through its thickness. These spurs are each shaped to receive a pin projecting from a protrusion of each support arm 10.

Each support arm 10 has one protrusion extending outwardly from the main length of the support arm 10. In the example shown in FIG. 2, the protrusion extends outwardly from the support arm general perpendicular to the length of the support arm 10. Since the support arm is upright in the example shown in FIG. 2, this means the protrusion extends in in a generally level (e.g. horizontal) direction.

In use, a lower surface (i.e. the underside) of each spur abuts an upper surface of a respective protrusion. This causes the drip tray 8 to be supported by the support arm 10. The pin extends upwardly from the upper surface of each respective spur into the through-bore of the respective spur. This provides a link between the support arm 10 and the drip tray 8 to avoid unintended lateral movement of the drip tray 8 relative to the support arm 10. In other examples, an alternative connection between the drip tray 8 and the support arms 10 may be provided. The pins of this example however allow the drip tray 8 to be removed from the support arms by lifting the drip tray 8 to cause the pins to become disengaged with the spur through-bores, thereby providing a simple means by which to remove the drip tray 8 from the support arms 10 when wanted. Additionally, the use of the pins provides good positional accuracy when replacing the drip tray 8 on the support arms 10.

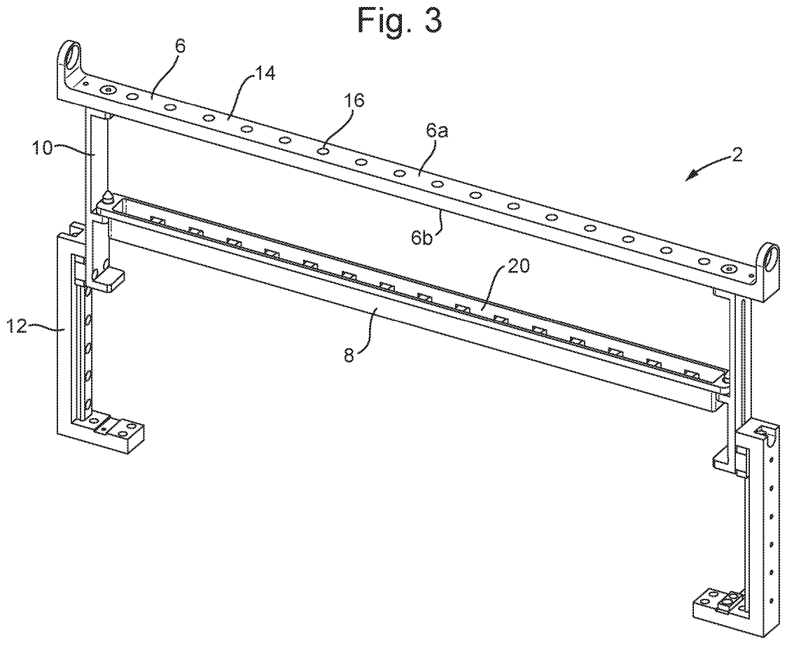

The holder 2 includes an adjustment mechanism which enables the frame 6 to be moved relative to the holder 2. Since the frame 6 and the drip tray 8 are located at a fixed distance from each other within the holder 2, movement of the frame 6 corresponds to movement of the drip tray 8. The adjustment mechanism comprises the support arms 10 and the support legs 12. Each support arm 10 is slidably mounted within a corresponding support leg 12. The slidable mounting is provided by a rail. The slidable mount allows both the frame 6 and drip tray 8 to be raised and lowered. The holder 2 therefore has a raised configuration, shown in FIG. 3, and a lowered configuration, shown in FIG. 2. Since the drip tray 8 and frame 6 are fixed to the support arms 10 the separation between the frame 6 and the drip tray 8 remains the same when the holder 2 is in both the raised and the lowered configurations.

The ability to raise and lower both the frame 6 and the drip tray 8 allows the user to easily access the frame 6 and drip tray 8 for cleaning and maintenance purposes. Furthermore, when the drip tray 8 is being used to store bottles, the ability to raise and lower the drip tray 8 provides the user with easier access to the bottles.

As set out above, the drip tray 8 is releasably coupled to the main body of the holder 2. This allows the drip tray 8 to be removed from the rest of the holder 2. The contents of the drip tray 8 can then be disposed of, and the drip tray 8 cleaned, with a reduced risk of contaminating the rest of the assay analyser during the cleaning process.

In the example shown in the figures, the mechanism that allows each support arm 10 to move relative to the respective support leg 12 is a linear bearing (not shown). The linear bearing is a reel which has a linear sliding bearing attached to it. This is located between the each support arm 10 and the respective support leg 12. In other examples alternative mechanisms, such as a motor or pulley may be used instead of the linear bearing.

When the holder 2 is moved to the raised configuration, the support arms 10 (and hence the frame 6 and drip tray 8) are maintained in the raised configuration. This is instead of returning under the influence of gravity to the lowered configuration. To achieve this, the support arms 10 are held in position relative to the support legs 12 by a gripping mechanism (not shown).

In the example shown in the figures the gripping mechanism is provided by a mechanical catch. The mechanical catch comprises a spring plunger that engages with a recess. The spring force exerted by the spring plunger is sufficient to hold the support arms 10, frame 6, drip tray 8 and pipette tips 4 in the raised configuration, but is able to be overcome by a user to return the holder 2 to the lower configuration. In an alternative example the mechanical catch is provided by magnetic plates. In use, the magnetic force produced by the magnetic plates is capable of holding the holder 2 in the raised configuration but is still able to be overcome by a user to move the holder 2 to the lower configuration. The spring plunger mechanism is simpler than using magnetic plates since the amount of space required for a spring plunger is less than would be needed for magnetic plates, which allows the support arms 10 and support legs 12 to be smaller. Additionally, given the various components of the holder 2, apart from the drip tray 8, are made from aluminium, multiple magnetic plates would need to be used instead of a single plate per support arm 10 and support leg combination.

A user manually moves the holder 2 to the raised position. To provide assistance to the user to achieve this, the frame 6 has handles at each end of the elongate bar. The handles are upstanding walls.

The handles each have an eyelet. The eyelets are sized to allow a user to insert a finger or thumb tip into the eyelet to help the user grip the handle.

The holder 2 also has a sensor at the base of at least one of the support legs 12. This is positioned so that when the holder 2 is moved to the lower configuration the sensor is activated. This passes a signal to the analyser to allow the analyser to be informed the holder 2 is in the lower configuration. In this example, the analyser is prohibited from operating when the holder 2 is not in the lower configuration. This avoids the holder 2 interfering with other components of the analyser as they are moved within the analyser and also means the holder 2 is in the correct position when it is to be used. Since the analyser uses robots to move pipette tips 4 and pipettors within the analyser that are programmed to move to particular positions, should the holder 2 not be in the appropriate position, it may not be possible to place the pipette tips 4 in the holder 2.

In the example shown in the figures, the sensor is a non-contact position sensor, such as an induction sensor. In other examples, the sensor may be a pressure sensor, such as a micro-switch, or a light sensor, such as a slot-optical sensor. The sensor is located on a surface of a foot of a support leg 12 that faces a surface of the respective support arm 10 when the holder 2 is in the lower configuration. This allows the sensor to detect when the holder 2 is in the lower configuration.

In some examples, the holder 2 has sixteen bores 16 and the drip tray 8 has sixteen sections 20. The holder 2 can therefore hold sixteen pipette tips 4, or the drip tray 8 can hold sixteen bottles.

In use, the analyser automates an assay that is being carried out on a batch of 16 samples, using four pipettors. The pipettors pick up new pipette tips 4 and perform an operation on samples 1-4 in the batch. The pipettors leave the used tips in the holder 2, by inserting the pipette tips 4 into the bores 16 in the frame 6, and pick up new pipette tips 4 to process samples 5-8. After all samples have been processed for the same operation, the pipettors pick up the used tips for samples 1-4 and perform the next assay step for samples 1-4, meaning four pipette tips 4 are saved from waste and fewer new tips are required by the machine. The separation of the bores 16 of the holder 2 matches the separation of the pipettors of the analyser. This allows easier loading and unloading of pipette tips 4 to and from the holder 2.

As mentioned above, the drip tray 8 can be loaded with reagent bottles. If pipettors do not eject used pipette tips 4 into the holder 2, but instead push the pipette tips 4 through the body of the holder 2 to the reagent bottles for aspiration of the fluid contents, then the holder 2 area can be used as a reagent reservoir for any assays that need reagents that cannot otherwise be accommodated in the other parts of the machine. Pipette tips 4 are able to be left in the holder 2 between uses while also having a second end 4b located in a respective reagent bottle. When this takes place a pipette tip 4 is able to be picked up by a pipettor and reagent drawn into the pipette tip 4 for use in the assay before the pipette tip 4 is removed from the holder 2.

In summary, as is clear from the above described embodiments, the holder 2 is able to isolate the used pipette tips 4 from new pipette tips 4 in order to prevent cross-sample contamination between used and unused pipette tips 4. The drip tray 8, positioned under the tips held by the frame 6, provides the safe management of liquid residue on the pipette tip 4 that may build up to a droplet over any ‘rest’ period while the pipette tip 4 is not being used. The assay analyser can move the holder 2 upwards to provide the user with access to the drip tray 8 for removal and cleaning of the drip tray 8.

The drip tray 8, which is also shaped to allow bottles to be installed, additionally provides a separate liquid waste area if liquids used in the assay are particularly noxious. Alternatively, the drip tray 8 can be used to repurpose the holder 2 as a reagent store where reagent bottles can be placed for fluid aspiration.

The present invention therefore provides a standalone assembly that can hold used disposable tips safely, without contaminating either the disposable tips or the rest of the analyser equipment, so that the pipette tips 4 can be reused later on if needed. Advantageously, this reduces the amount of plastic waste produced by the machine, as well as reducing the costs associated with purchasing and storing new pipette tips 4.

The holder 2 is able to be fitted as a component in an analyser during the manufacture or to be retrofitted into an analyser. When the drip tray is used to catch fluid, in the examples described herein the drip tray is intended to be emptied at the end of each day of use. In some examples this may be after seven assay runs, meaning the pipette tips located in the holder may each be used seven times. This reduces the number of pipette tips used by 50%.

The reduction in the number of pipette tips used when using the holder 2 is partially due to the fluid held within the pipette tips 4 stored in the holder 2. Typically the pipette tips that are stored in the holder 2 are used to transport wash fluid or waste fluid within the analyser. This means the chances of contamination being caused is reduced since sample fluid is not generally held within these pipette tips.

While the drip tray could be left for more assay runs without needing to be emptied, if the drip tray is left in the analyser for an extended period while the analyser is not in use, such as overnight, liquid in the drip tray is likely to at least partially evaporate. This can cause other parts of the analyser to become contaminated. Due to this undesirable effect, this is why the drip tray is intended to be emptied at the end of each day.

1. A holder for holding pipette tips of a molecular diagnostics assay analyser, the holder comprising:
a frame comprising a plurality of bores which are separated from each other, each bore configured to removably hold a first end of a pipette tip; and
a drip tray spaced apart from the plurality of bores, the drip tray configured to receive a second end of a pipette tip when said pipette tip is held by one of the plurality of bores, thereby allowing the pipette tip to be placed in the holder for re-use, wherein the drip tray is detachable from the holder.

2. The holder according to claim 1 wherein each bore has a central longitudinal axis and the central longitudinal axes of the plurality of bores are substantially parallel to each other.

3. The holder according to claim 1 wherein the bores are through-bores.

4. The holder according to claim 3 wherein each of the plurality of the bores extends along a portion of the pipette tip from the first end of the pipette tip towards the second end of the pipette tip.

5. The holder according to claim 4 wherein the extent of the pipette tip along which the bore extends is chosen such that each bore holds a pipette tip in a manner which prevents a longitudinal axis of the pipette tip from substantially deviating from a longitudinal axis of the bore, such that substantial lateral motion of the pipette tip in the bore is prevented.

6. The holder according to claim 1 wherein the plurality of bores are linearly arranged within the frame.

7. The holder according to claim 1 further comprising a gap between the frame and the drip tray.

8. The holder according to claim 1 wherein the drip tray is partitioned into a plurality of sections.

9. The holder according to claim 8 wherein the number of sections in the drip tray is equal to the number of bores in the frame.

10. The holder according to claim 8 wherein each section is arranged opposite a corresponding bore in the frame.

11. The holder according to claim 8 wherein the sections are configured to receive a bottle.

12. (canceled)

13. The holder according to claim 1 wherein the frame is movable between a raised position and a lowered position within the holder.

14. The holder according to claim 13 wherein the separation between the drip tray and the plurality of openings is the same when the frame is in both the raised position and the lowered position.

15. The holder according to claim 13 further comprising an adjustment mechanism configured to move the frame between the raised position and the lowered position.

16. The holder according to claim 15 wherein the adjustment mechanism comprises a gripping mechanism configured to maintain the frame in the raised position.

17. The holder according to claim 16 wherein the gripping mechanism comprises a mechanical catch.

18. The holder according to claim 13 further comprising a sensor configured to detect when the frame is in the lowered position.
